(19) United States
(12) Patent Application Publication
(10) Pub. No.: US 2012/0088110 A1
(43) Pub. Date: Apr. 12, 2012

(54) PROCESS FOR SURFACE PREPARATION OF POLYAMIDE ARTICLES FOR METAL-COATING

(75) Inventors: Andri E. ELIA, Chadds Ford, PA (US); Charles J. DUBOIS, Wilmington, DE (US); Juan Carlos FIGUEROA, Wilmington, DE (US)

(73) Assignee: E. I. DU PONT DE NEMOURS AND COMPANY, Wilmington, DE (US)

(21) Appl. No.: 13/251,482

(22) Filed: Oct. 3, 2011

Related U.S. Application Data
(60) Provisional application No. 61/390,231, filed on Oct. 6, 2010.

(51) Int. Cl. B32B 15/08; B05D 7/02; B05D 3/10

(52) U.S. Cl. 428/458; 427/307

(57) ABSTRACT

This invention relates in part to processes wherein a polyamide polymer surface is chemically treated prior to applying a coating containing metal, and such metal coated polyamide articles. Treatment of the polyamide surface with an aqueous base wash after surface preparation with acid results in polyamide surfaces which provide superior adhesion to metals than polyamide surfaces which have not undergone a base wash before metal deposition.

### CROSS REFERENCE TO RELATED APPLICATIONS

This application claims the benefit of U.S. Provisional Application No. 61/390,231, filed Oct. 06, 2010, now pending, the entire disclosure of which is incorporated herein by reference.

### FIELD OF THE INVENTION

This invention relates in part to processes wherein a polyamide polymer surface is chemically treated prior to applying a coating containing metal, and such metal coated polyamide articles.

### BACKGROUND OF THE INVENTION

Plastic or polymeric articles can be coated with a thin layer of metal for aesthetic, conduction, and static reduction purposes. Coating polymeric articles with metal can be difficult because traditional metal coating methods rely on high temperatures or electrical conductivity, neither of which will work for polymeric articles. Some methods for applying a metal coating on polymeric articles use some of the same principles as those used to coat metal parts, but with some differences to take into account the material properties of the polymeric articles.

Methods used for metal-coating plastic or polymeric parts include electroless plating, vapor deposition, and conductive paints. One method uses a combination of electroless plating and electrolytic plating to coat the polymeric article. When a metal in elemental form is coated as a layer onto a polymeric or plastic article surface, the ability to obtain a tenacious or strong bond of the metal layer to the polymeric article surface can be difficult.

The bond between the metal and polymer surface, which is referred to as adhesion and which is measured by peel strength, should be strong enough so that it does not fail during normal use of the article. In order to improve adhesion between the metal and polymer surface, the polymer surface is typically etched.

Strong acid or base solutions are sometimes used to etch the surface of a polymer so that when a metal is applied to the polymer surface, the adhesion or bonding of the metal is improved. Numerous variations have been used in an attempt to improve the etching process.

U.S. Pat. No. 3,668,130 teaches the use of a chromic acid solution to etch polymeric resin surfaces before the resin surfaces are electrolessly plated with copper followed by electrolytically plating the resin surface with metal. Average adhesion values between the metal layer and resin were in the range of 20 lbs./inch to 22.25 lbs./inch for a 4 mil thick plate.

U.S. Pat. No. 5,192,590 discloses that a surface of a poly(aryl ether ketone) composition with substantial amounts of glass and/or mineral filler may be subjected to a solution of 300 to 350 grams per liter of ammonium bifluoride and 5.5 to 6.5 wt % sulfuric acid, for 4 to 10 minutes. Complete dissolution of all exposed glass and mineral fillers can be completed by a further immersion in 25% sulfuric acid in water for 10 to 30 minutes. Thereafter, the article is metal coated by plating.

WO1990005203 teaches that plastics of functionalized polymers having at least one hydrolyzable functionality such as anhydride ester (carboxyl and sulfonic), amide, urethane and imide, preferably polycarbonate, can be swollen and etched for plating by certain swelling agents and degradation agents, in one, two or three steps. The etched surface provides satisfactory adhesion of electroless nickel or copper. The polymers can be swollen and etched in one bath by using a mixture of swelling (or wetting agent) and degradation agents or with a compound having the ability to swell and etch the polymers simultaneously. In the two-step process, swelling and degradation is done separately. In the three-step process, the plastic surface is swollen and etched with mineral acids followed by treatment with a base.

U.S. Pat. No. 5,591,354 teaches a process of etching the surface of polymeric materials made of polymers having at least one oxidatively degradable functionality which comprises treating said surface with a solution of at least one member of the etchant group consisting of nitronium, nitrosonium ions and complexes thereof, in a solvent containing less than 40% by weight of water and nitroacidium ions and complexes thereof. The etched surfaces can be coated with paints or metals'

U.S. Pat. No. 4,335,164 teaches that polyamide substrates can be pre-conditioned for electroless plating by contact with an aqueous alkaline solution having a pH of at least about 10 and etched with an aqueous acid etch solution of an organic acid containing at least two carbon atoms, in combination with from 1 to 10 percent by weight of an inorganic acid which is nondeleteriously reactive with the organic acid. Trichloroacetic acid is the preferred organic acid and sulfuric, hydrochloric and/or nitric the preferred inorganic acids. This process improves the adhesion of deposited metal plate onto the polymer surface.

The object of the present invention is to provide an improved etching process for achieving a metal coating on the surface of a polyamide article resulting in a strong bond of the metal with the polyamide article.

### SUMMARY OF THE INVENTION

Disclosed herein is a process for preparing a polyamide article comprising an acid-etchable component for applying a metal coating to said article, the process comprising the steps of:
(i) treating the polyamide article with an acidic etching treatment to obtain an acid treated polyamide article;
(ii) treating the acid treated polyamide article with a fluoride etching solution to obtain a fluoride treated polyamide article
(iii) treating the fluoride treated polyamide article with a base wash having a pH of between 9-12 to obtain a base washed polyamide article; and
(iv) optionally, applying a metal coating to the base washed polyamide article to obtain a metal-coated polyamide article.

### DETAILED DESCRIPTION

Many articles are made from polymer compositions which have a metal coating. It is desirable for the metal coating to be strongly bonded to the surface of the polymer so that the coating cannot be easily removed or compromised in normal use.

One method for coating a metal onto the surface of a polymeric article uses a combination of etching the polymeric surface with a strong acid solution followed by an electroless plating step and concluding with an electrolytic step to obtain a metal-coated polymeric article.

The specific class of polymer to be coated can have a dramatic effect on the effectiveness of the etching and plating steps. The type and concentration of acid or base used is determined by the specific class of polymer to be metal coated. For purposes of this invention, polyamide polymers are the class of polymers that the recited process is effective for making metal coated polymeric articles.

### Definitions

As used herein, the terms “about” and “at or about” mean that the amount or value in question may be the value designated or some other value approximately or about the same. The term is intended to convey that similar values promote equivalent results or effects recited in the claims.

As used herein, the terms “comprises,” “comprising,” “includes,” “including,” “has,” “having” or any other variation of these, refer to a non-exclusive inclusion. For example, a process, method, article, or apparatus that comprises a list of elements is not limited to only the listed elements but may include other elements not expressly listed or inherent. Further, unless expressly stated to the contrary, “or” refers to an inclusive, not an exclusive, or. For example, a condition A or B is satisfied by any one of the following: A is true (or present) and B is false (or not present), A is false (or not present) and B is true (or present), and both A and B are true (or present).

As used herein, the term “metal coating” when used as a noun means a thin, typically 0.1 microns to two or several hundred microns thickness. As a verb, “metal-coating” means applying to a polymer surface a metal, using known metal-coating or metal-plating processes such as electroless plating, electroplating, spraying, vapor deposition, powder coating, immersion processes, and solution dipping processes. Metals suitable for the present invention can be any metal such as copper, nickel, iron, cobalt, silver, zinc, titanium, platinum, palladium, aluminum, tin, lead, and other metals or any combination of metals to make a metal alloy. This definition also includes multiple layers of different metals.

As used herein, the term “acid etchable component” means a component which has a surface which, when exposed to a chemical, the area of the surface exposed reacts with that chemical causing the surface to be altered in some manner. The altered component surface can then be removed from the unaltered component surface.

As used herein, the term “etching treatment” means a treatment solution which chemically reacts with a polymer or component surface causing the reacted polymer or component surface to be altered.

As used herein, the term “base wash” means an aqueous composition containing a mineral or organic base compound which causes the composition to have a pH which is greater than 7 (such as 8 or 9) but less than or equal to about 12.

### Polyamide Polymers

Suitable polyamides for this invention can be condensation products of one or more dicarboxylic acids and one or more diamines, and/or one or more aminocarboxylic acids, and/or ring-opening polymerization products of one or more cyclic lactams. Polyamides may include aliphatic, aromatic, and/or semi-aromatic polyamides and can be homopolymer, copolymer, terpolymer or higher order polymers. Blends of two or more polyamides may also be used.

Suitable dicarboxylic acids include, but are not limited to, adipic acid, azelaic acid, terephthalic acid, isophthalic acid, sebacic acid, and dodecanedioic acid. Preferred dicarboxylic acids are adipic, isophthalic and terephthalic acid. A suitable aminocarboxylic acid is 11-aminododecanoic acid. Suitable cyclic lactams include caprolactam and laurolactam.

Suitable aliphatic diamines include, but are not limited to, tetramethylenediamine; hexamethylenediamine; octamethylenediamine; nonamethylenediamine; 2-methylpentamethylenediamine; 2-methyloctamethylenediamine; trimethylhexamethylenediamine; bis(p-aminocyclohexyl)methane; m-xylylenediamine; p-xylylenediamine, decamethylenediamine; undecamethylenediamine; dodecamethylenediamine; tridecamethylenediamine; tetramethylenediamine; pentamethylenediamine; hexamethylenediamine; and the like.

Suitable aromatic and/or heterocyclic diamines can be represented by the structure: H₂N—R₁₀—NH₂, wherein R₁₀ is an aromatic group containing up to 16 carbon atoms and, optionally, containing up to one hetero atom in the ring, the hetero atom comprising —N—, —O—, or —S—. Also included herein are those R₁₀ groups wherein R₁₀ is a diphenylene group or a diphenylmethane group. Representative of such diamines are 2,6-diaminopyridine, 3,5-diaminopyridine, metaphenylene diamine, para-phenylene diamine, p,p′-methylene dianiline, 2,6-diamino toluene, and 2,4-diamino toluene.

Other examples of the aromatic diamine components, which are merely illustrative, include benzene diamines such as 1,4-diaminobenzene, 1,3-diaminobenzene, and 1,2-diaminobenzene; diphenyl(thio)ether diamines such as 4,4′-diaminodiphenylether, 3,4′-diaminodiphenylether, 3,3′-diaminodiphenylether, and 4,4′-diaminodiphenylthioether; benzophenone diamines such as 3,3′-diaminobenzophenone and 4,4′-diaminobenzophenone; diphenylphosphine diamines such as 3,3′-diaminodiphenylphosphine and 4,4′-diaminodiphenylphosphine; diphenylalkylene diamines such as 3,3′-diaminodiphenylmethane, 4,4′-diaminodiphenylmethane, 3,3′-diaminodiphenylpropane, and 4,4′-diaminodiphenylpropane; diphenylsulfide diamines such as 3,3′-diaminodiphenylsulfide and 4,4′-diaminodiphenylsulfide; diphenylsulfone diamines such as 3,3′-diaminodiphenylsulfone and 4,4′-diaminodiphenylsulfone; and benzidines such as benzidine and 3,3′-dimethylbenzidine.

Preferred diamines include hexamethylenediamine, 2-methylpentamethylenediamine, decamethylenediamine, and dodecamethylenediamine.

Preferred polyamides include aliphatic polyamides such as polyamide 6; polyamide 6,6; polyamide 4,6; polyamide 6,9; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; polyamide 6,13; and semi-aromatic polyamides such as poly(m-xylene adipamide) (polyamide MXD,6) and polyterethalamides such as poly(dodecamethylene terephthalamide) (polyamide 12,T), poly(decamethylene terephthalamide) (polyamide 10,T), poly(nonamethylene terephthalamide) (polyamide 9,T), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T); hexamethylene isophthalamide and hexamethylene adipamide (polyamide 61/66); hexamethylene adipamide/hexamethylene terephthalamide/hexamethylene isophthalamide copolyamide (polyamide 6,6/6,T/6,I); poly(caprolactam- hexamethylene terephthalamide) (polyamide 6/6,T); and copolymers and mixtures of these polymers.

Examples of suitable aliphatic polyamide copolymers and terpolymers include polyamide 66/6 copolymer; polyamide 66/68 copolymer; polyamide 66/610 copolymer; polyamide 66/612 copolymer; polyamide 66/10 copolymer; polyamide 66/12 copolymer; polyamide 6/68 copolymer; polyamide 6/610 copolymer; polyamide 6/612 copolymer; polyamide 6/10 copolymer; polyamide 6/12 copolymer; polyamide 6/66/610 terpolymer; polyamide 6/66/69 terpolymer; polyamide 6/66/11 terpolymer; polyamide 6/66/12 terpolymer; polyamide 6/610/11 terpolymer; polyamide 6/610/12 terpolymer; and polyamide 6/66/PACM (bis-p-{aminocyclohexyl} methane) terpolymer.

Exemplary polyamides include hexamethylene adipamide (to give polyamide PA66), hexamethylene terephthalamide (to give polyamide PA6T), hexamethylene isophthalamide (polyamide PA6I), 2-methyl pentamethylene terephthalamide (to give polyamide PADT), p-phenylene terephthalamide, m-phenylene adipamide, and the like or combinations of them.

Preferred polyamides are aliphatic or aromatic polyamides or blends of two or more polyamides. Preferred polyamides have a Tg greater than 40° C., preferably greater than 80° C. and most preferably greater than 110° C. Preferred polyamides have a melting point greater than 200° C., preferably greater than 260° C., and most preferably greater than 290° C.

The polyamide polymers of the present invention can have one or more additives such as fiber(s), particle(s), filler(s), stabilizer(s), and the like, where a surface of the polymer is coated by at least one metal in elemental form (“metal” unless otherwise specified).

Physical blends of aliphatic polyamides and semiaromatic polyamides are useful in articles to obtain properties intermediate between or synergistic of the properties of each polyamide. However, it has been noted that semiaromatic polyamides in comparison to aliphatic polyamides are more difficult to coat with a metal or metals that remains tenaciously bonded to the surface, as desired,and physical blends containing semiaromatic polyamide and aliphatic polyamide can be more difficult to coat than the same aliphatic polyamide. Blends may be expressed by known abbreviations, such as PA6T/DT for a blend of two polyamides, PA6T and PADT. Some amount of copolymers may also be present.

A preferred blend of polyamides is one having both an aliphatic and a semiaromatic polyamide. One such preferred blend is a blend having an aliphatic polyamide with mostly (>50%) or almost all (>90%) hexamethylene adipamide, or poly(hexamethylene adipamide) itself, optionally in combination with a semiaromatic polyamide having mostly (>50%) or almost all (>90%) hexamethylene terephthalamide monomer instances and/or hexamethylene isophthalamide monomer instances, with the ratio of the two being greater than or less than or equal to one or more of 0.2, 0.5, or 0.8 (e.g. copoly(hexamethylene isophthalamide (0.666 parts)-hexamethylene terephthalamide (0.334)).

The polyamide polymer that is suitable herein may comprise one or more mixtures of fiber(s). Each fiber can be chopped into lengths or “continuous” and have various diameters, cross sections, lengths, and aspect ratios. The fiber may comprise ingredients such as glass, carbon, graphite, and polymer. A preferred fiber is short chopped glass fiber with a flattened cross section, in a ratio by weight to the polyamide blend of about 0.2, 0.5, 1, 2, or 5. The weight percentage of fiber used in a polymer composition can be from about10 to about 60 weight percent, based on the total weight percent composition of the polyamide polymer and fiber.

An optional ingredient of the polyamide polymer composition is one or more mineral fillers, such as calcium carbonate particles, clay particles, or the like. Any filler can have various average diameters, cross sections, lengths, and aspect ratios; the filler can include ingredients such as glass, carbon, graphite, polymer, and the like. A preferred filler is calcium carbonate particles. The weight percentage of filler used in a polymer composition can be from about 1 weight percent to about 50 weight percent based on the total weight percent of the total composition.

Certain types of fillers are extractable by the surface preparation process for metallization, thereby creating surface roughness which can improve adhesion of the polyamide article to the metal coating. These acid-etchable fillers suitable for the invention disclosed herein can be any filler which can be removed by the surface preparation process. The fillers can be used alone or in combination with other fillers. One preferred acid-etchable filler is CaCO₃. The total weight percentage of acid-etchable fillers used in the polyamide article of this invention can be from about 1 weight percent to about 30 weight percent based on the total weight percent of the polyamide article.

Additional components which may be acid-etchable include tougheners (rubber-like), small polymeric molecules.

The polymer composition can optionally include other ingredients, such as catalyst, polymers other than polyamide, adhesion promoters, ions, compounds, preservatives such as heat stabilizers and antioxidants, lubricants, flow enhancers, or other ingredients as known in the art.

In general, the process for coating a polyamide article with metal comprises several steps. First, the polyamide polymer surface is treated by etching the polymeric article surface with a concentrated acid solution or concentrated acid mixture, both of which are referred to herein as an acid etching solution. The polymer surface preparation may include other steps besides etching. The treated polymer surface is then activated with metal ions followed by electroless plating with a metal. The final step is electrolytically plating a metal onto the polymer surface. Certain steps are typically conducted sequentially, in which case it can be advantageous to carry out pretreatments or post treatments (such as washing, cleaning, drying, heating, and partial or full neutralization of pH extremes) while optionally the treating solutions are agitated or undergo ultrasonification during these operations.

### Surface Preparation Process

Etching: The first step or operation of the invention is exposure of at least part of a polyamide article surface to acidic etching treatment, using an aqueous acidic liquid mixture. The acidic liquid mixture can have dissolved, dispersed, or undissolved components, and can include one or more solvents such as water, ethylene glycol, and the like. The dissolved and undissolved components can include ions, ionic and covalent compounds including organic compounds or elements. Examples include hydronium ion; hydroxide ion; chloride ion; sulfate ion, bisulfate ion, fluoride ion, bifluoride ion, ammonium ion; sodium ion, ionic and elemental metals such as iron, nickel, cobalt, chromium, and the like in charge states such as 0, +1, +2, +3, +6 or compounds such as hydrogen chloride. The amount of any component of a treating liquid mixture can be greater than, equal to, or less than one or more of 0.1, 1, 5, 10, 30, 50, 90, or 95 weight %.

The pH of the aqueous acidic liquid mixture used to treat the polymeric article surface can be an important aspect of treatment, as can treating temperature, agitation and time. The aqueous acidic liquid mixture typically has a pH of 3 or less but can be greater depending on the specific process used. Acidity can be established by the use of acids such as inorganic and organic acids. Non-limiting examples of inorganic acids include hydrochloric acid, sulfuric acid, nitric acid, and hydrofluoric acid. Non-limiting examples of organic acids include oxalic acid, acetic acid, benzoic acid, or the like. Buffers can also be used, established by the presence of one or more of bicarbonate, bifluoride, bisulphate, or similar compounds, with one or more of carbonic acid, carbonate, hydrofluoric acid, fluoride, sulfuric acid, sulfate, or similar compounds.

Acid treatments are carried out at from ambient temperatures to about 85° C. in air or optionally under nitrogen, argon, or other inert gases for about 10 to 15 minutes resulting in an acid treated polyamide article.

Fluoride Rinse: The second step in the surface preparation process of the invention is exposure of the acid treated polyamide article to fluoride etching solution, wherein the solution is an aqueous fluoride solution such as ammonium hydrogen bifluoride HNH₄F₂ (at 80 gr/lit) at 20-25° C. for 5 to 15 minutes. Sodium bifluoride could also be used in this step. It is preferable that the aqueous fluoride solution pH be higher (less acidic) than the pH of the first acid treatment step.

Exposure of the polyamide article surface to an aqueous fluoride solution can also be carried out before the acid treatment of the first step. Additional acid or fluoride treatments or a combination of these can be carried out more than once. The fluoride step results in a fluoride treated polyamide article.

Base wash: Typically, the fluoride treated polyamide article is washed with water before the polyamide polymer surface is activated by metal ions. However, it has been surprisingly found that after the fluoride treated polyamide article is washed with water, if the fluoride treated polyamide article is subsequently washed with a slightly alkaline aqueous solution having a pH of between 9 and 12, and then washed again with water, the resulting base washed polyamide article provides a polymeric surface that provides for excellent metal bonding. It is believed that this aqueous alkaline wash step does not react with the polymer surface due to its pH which is only mildly basic. Any mineral base containing a group I or group II cation such as lithium hydroxide, sodium hydroxide, potassium hydroxide, magnesium hydroxide, and calcium hydroxide can be used to make the alkaline aqueous solution as long as the pH is between 9 and 12, preferably 10-12. Organic bases such as ammonium hydroxide can also be used to make the alkaline aqueous solution.

Experimental results show that performing the same surface preparation process, but without the aqueous alkaline wash step, resulted in polyamide polymer surfaces having inferior metal adhesion or peel strength after the metal plating process.

### Metal Plating Process

After undergoing the surface preparation treatment steps, the base washed polyamide article is ready to undergothe metal-coating step. Typically during the metal-coating step the surface-treated article undergoes a series of chemical reactions to render conductive the portion of its surface that is to be metal plated: first a catalyst is applied on the surface followed by a chemical (electroless) deposition of a thin layer of metal, enough to render at least part of the surface of the article conductive. The metal used for electroless deposition is typically Copper or Nickel, but other metals may be used. After this step, electrolytic deposition of additional metal is possible to the desired thickness.

The metal coating can comprise at least one metal in elemental form, alloys of such, or metal matrix composites. The coating may be applied layer by layer, and can have a thickness of from less than 1 micron to more than 50 microns, preferably from less than 5 micron to more than 20 microns, and more preferably from 10 microns to 20 microns to achieve a metal coating having the thickness as described once all coatings are appled. It is often useful to apply more than one layers of different metals in a combination that may offer a desired advantage. For example, a more ductile metal such as copper may be used for the first layer, and a stronger metal, such as nickel, iron, cobalt, tin, or other metals or their alloys, or alloys with phosphorus, may be used for the outer layer for their strength and hardness.

Drip drying and water rinse operations in the above surface preparation and metal coating processes can be from a few seconds to several minutes. The purpose of the drip drying operation is to remove and collect residual treatment chemicals so they do not interfere with future processing steps as well being collected for recycling. The drip drying operation is optional but could result in the water rinses containing additional treatment chemicals. The purpose of the water rinse operation is to remove residual treatment chemicals still on the polyamide polymer surface so there is no contamination of the polyamide polymer surface that could interfere with the next step in the process. Deionized water is preferably used in the water washing operations. The number of drip drying and water wash operations as well as the length of time that each operation is performed is within the skill level of one knowledgeable in the art.

The strength of the bond between the metal coating and the polyamide polymer surface is determined by measuring the peel strength of the metal-polymer interface. Peel strengths/adhesion between polyamide resins and metal coated on the polymer have traditionally only been used for decorative/aesthetic applications due to their poor adhesion performance. Increasing the peel strengths/adhesion between the substrate and deposited metals from 5-7 N cm⁻¹ to >12 N cm⁻¹ allows use of the metal coated polyamide article in more demanding higher performance applications.

Applications where favorable or improved peel strength is desirable include electrical and electronic components, personal digital assistant (PDA), cell and mobile phone components, computer notebook components, and the like, automotive components, aerospace parts, defense parts, consumer products, medical components and sporting goods. Suitable parts include tubes or shafts used in sporting goods such as ski and hiking poles, fishing rods, golf club shafts, hockey sticks, lacrosse sticks, baseball/softball bats, bicycle frames, skate blades, snow boards. Other applications include plates such as golf club head face plates and complex shapes such as sports racquets (tennis, racquetball, squash and the like), golf club heads, automotive grill-guards, pedals such as brake and gas petals, fuel rails, running boards, spoilers, muffler tips, wheels, vehicle frames, structural brackets, and similar articles.

The article, whose surface is to be coated with metal, can be formed by processes such as by injection molding a polymer composition and subsequently removing the molded article from the mold and cooling.

### Examples

The present invention is further defined in the following Examples. It should be understood that these Examples, while indicating various and preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

All percentages are by weight unless otherwise specified.

### Peel Strength

Peel strength of the metal from the metal-coated articles was measured by a Z005 tensile tester (Zwick USA LP, Atlanta, Ga.) with a load cell of 2.5 kN using ISO test Method 34-1. Ametal-coated plaque was fixed on a sliding table which was attached to one end of the tensile tester. Two parallel cuts 1 cm apart was made into the metal surface so that a band of metal on the surface 1 cm wide was created. The table slid in a direction parallel to the cuts. The 1 cm wide copper strip was attached to the other end of the machine, and the metal strip was peeled (at a right angle) at a test speed of 50 mm/min (temperature 23° C., 50% relative humidity). The peel strengths of each example are shown in Table X.

### Compositions

Polymer compositions used for both the examples and comparative examples are prepared as described below. Polyamide composition 1 was prepared by blending the following components: 34.15 parts polyamide 6,6 (PA66) made of 1,6-diaminohexane and 1,6-hexanedioic acid; 15 parts amorphous polyamide B composed of 1,6-diaminohexane, 70 mole percent isophthalic acid and 30 mole percent terephthalic acid (mole percents based on total amount of dicarboxylic acids present in polyamide B); 0.40 parts Chimassorb 944 also known as poly[(6-[(1,1,3,3-tetramethylbuty)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]); 0.20 parts Irganox 1098 also known as 3,3′-bis(3,5-di-tert-butyl-4-hydroxyphenyl)-N,N′-hexamethylenedipropionamide; 0.25 parts LICOMONT ® CAV 102, a calcium salt of montanic acid crystallization promoter available from Clariant GmbH, Augsburg, Germany; 10 parts SUPER-PFLEX 200, a surface-treated, fine particle size, precipitated calcium carbonate with narrow particle size distribution available from Specialty Minerals, Inc., Bethlehem, Pa. having a typical 2% stearic acid surface treatment, average particle size 0.7 microns, +325 mesh residue of 0.03 weight percent, and surface area of 7 meters2/gram; and 40 parts flat glass fibers, namely NITTOBO CSG3PA-820, 3 mm long, 28 microns wide, 7 microns thick, aspect ratio of cross-sectional axes equaling 4, having aminosilane sizing, from NITTO BOSEKI, Japan.

Pellets of polyamide composition 1 were prepared by melt blending the components and the glass fibers were fed into the molten polymer matrix with a side feeder. Pelletizing temperature was approximately 280 to 310° C. Upon exiting the strand die, they were quenched in water and pelletized. The pellets are approximately 3 mm in diameter and 5 mm in length. The thus prepared pelletized composition was then dried at 100° C. for 6-8 hours in dehumidified dryer and then molded into a standard ISO 294 type D2 plaque of 6 cm×6 cm×2 mm, at a melt temperature of 280 to 300° C. and mold temperature of 85-105° C. to provide plaques of polyamide composition 1.

Polyamide composition 2 was prepared by blending the following components: 49 parts polyamide 6,6 made of 1,6-diaminohexane and 1,6-hexanedioic acid having a melting point of about 260-265° C. and a Tg of about 60° C.; 0.40 parts Chimassorb 944 also known as poly[(6-[(1,1,3,3-tetramethylbuty)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]); 0.20 parts Irganox 1098 also known as 3,3′-bis(3,5-di-tert-butyl-4-hydroxyphenyl)-N,N′-hexamethylenedipropionamide; 0.25 parts LICOMONT ® CAV 102, a calcium salt of montanic acid crystallization promoter available from Clariant GmbH, Augsburg, Germany; 10 parts SUPER-PFLEX 200, a surface-treated, fine particle size, precipitated calcium carbonate with narrow particle size distribution available from Specialty Minerals, Inc., Bethlehem, Pa. having a typical 2% stearic acid surface treatment, average particle size 0.7 microns, +325 mesh residue of 0.03 weight percent, and surface area of 7 meters2/gram; 40 parts glass fibers, namely PPG 3540 of nominal length 3.2 mm, available from PPG Industries, Pittsburgh, Pa. 15272, USA.

Pellets of polyamide composition 2 were prepared by melt blending in the same manner as for polyamide composition 1. Pelletizing temperature was approximately 310 to 330° C. . Plaque specimens were analogously prepared at a melt temperature of 280 to 310° C. and mold temperature of 90-110° C.

### Processes

The polyamide compositions 1 and 2 were then treated to either process 1 or process 2. Examples E1 and E2 of the invention were treated using process 2 which incorporates the aqueous base wash step. Comparative examples C1 and C2 were treated using process 1 which does not contain a base wash step.

In the case of process 1, the surface of the plaque was prepared by etching for about 12.5 minutes at about 50° C. with using a solution of PM-847 in ethylene glycol (approximately 250 mL/L, where PM-847 is about 22.5 weight percent calcium chloride and about 13.75 weight percent hydrogen chloride, obtained from Rohm and Haas Company, Philadelphia, Pa.). This was followed by removing the sample from the bath, drip drying for 1 minute, followed by a water rinse for 5 minutes at room temperatures, then an additional surface preparation steps of immersion in a 5% ammonium hydrogen bifluoride HNH4F2 solution in H2O for about 5 minutes at about 15° C.-25° C., followed by a drip dry for 1 minute. This was followed by two water rinses for about 1 minute each at room temperature. The surface preparation steps were followed by activation with a solution of palladium ions using Noviganth PA Activator (a solution of 150 ppm palladium ions obtained from obtained from Atotech USA, Rock Hill, S.C.) for about 6 minutes at about 30° C. followed by a drip dry for about one minute, then a rinse in water for about 1 minutes. The activated surface was then treated with Noviganth PA Reducer (commercial kit obtained from Atotech USA, Rock Hill, S.C. and used recommended conditions in technical data sheet) for about 6 minutes at about 45° C. The sample was removed from the treatment bath and allowed to drip dry for about 1 minute followed by a rinse for about 1 minute at room temperature. Electroless nickel deposition was applied using Noviganth Ni PA (commercial kit obtained from obtained from Atotech USA, Rock Hill, S.C. and used recommended conditions in technical data sheet) for about 10 minutes at about 55° C., followed by a water rinse for about 1 minute at room temperature. This was followed by galvanic deposition of a second metal layer of the metal volume, about a 20 micron thickness of metallic copper from aqueous copper sulphate solution containing copper sulphate (5 H₂O) 180-220 g/L; sulfuric acid (96%) 35-45 m/L; chloride ion 70-120 ppm; 33-35° C.; 2 minute strike at 0.5 A followed by 40 minutes treatment at 3 A) followed by a water rinse for 1 minute at room temperature, and banishing by drying the article for 40 minutes at room temperature, followed by a water rinse for 1 minute at room temperature, and banishing by drying the article.

In the case of process 2, the surface of the plaque was prepared by etching the plaque in a solution of PM-847 and immersion in a 5% ammonium hydrogen bifluoride HNH4F2 solution as in process 1. The sample was then treated for 30 minutes in a base wash solution for about 30 minutes at about room temperature followed by a rinse of about 30 minutes. The base wash solution was about 0.01 M ammonium hydroxide in the case of Example 1, and about 0.01 M sodium hydroxide in the case of Example 2. The surface preparation steps were followed by the same metallization steps as process 1: Activator, Reducer, Electroless nickel deposition, and 20 micron thickness galvanic deposition of copper.

It is seen in Table 1 that the use of a base wash step results in an improvement in the peel strength for examples E1 and E2 compared to their respective comparative examples C1 and C2 of at least 53% (E1 vs. C1).

### Metallization Process 1

| | | Time | Optimum |
|---|---|---|---|
| Step # | Process Step | [min.] | Temperature [° C.] |
| 1 | Rohm & Haas PM-847 | 12.5 | 50 |
| | Etch | | |
| 2 | Drip Dry | 1 | room temperature |
| 3 | Rinse | 5 | room temperature |
| 4 | Aqueous Ammonium | 5 | room temperature |
| | Bifluoride [8% w/w] | | |
| 5 | Drip Dry | 1 | room temperature |
| 6 | Rinse | 1 | room temperature |
| 7 | Atotech Noviganth PA | 6 | 35 |
| | Activator | | |
| 8 | Drip Dry | 1 | room temperature |
| 9 | Rinse | 1 | room temperature |
| 10 | Atotech Noviganth PA | 3 | 45 |
| | Reducer | | |
| 11 | Drip Dry | 1 | room temperature |
| 12 | Rinse | 1 | room temperature |
| 13 | Atotech Noviganth Ni | 10 | 55 |
| | PA | | |
| 14 | Rinse | 1 | room temperature |
| 15 | Copper electroplating | 40 | 35 |
| 16 | Rinse | 1 | room temperature |

AD7853USNA

Metallization Process 2

| | | Time | Optimum |
|---|---|---|---|
| Step # | Process Step | [min.] | Temperature [° C.] |
| 1 | Rohm & Haas PM-847 | 12.5 | 50 |
| | Etch | | |
| 2 | Drip Dry | 1 | room temperature |
| 3 | Rinse | 5 | room temperature |
| 4 | Aqueous Ammonium | 5 | room temperature |
| | Bifluoride [8% w/w] | | |
| 5 | Drip Dry | 1 | room temperature |
| 6 | Rinse | 1 | room temperature |
| 7 | Rinse | 1 | room temperature |
| 8 | Base wash | 30 | room temperature |
| 9 | DI water rinse | 30 | room temperature |
| 10 | Atotech Noviganth PA | 6 | 35 |
| | Activator | | |
| 11 | Drip Dry | 1 | room temperature |
| 12 | Rinse | 1 | room temperature |
| 13 | Atotech Noviganth PA | 3 | 45 |
| | Reducer | | |
| 14 | Drip Dry | 1 | room temperature |
| 15 | Rinse | 1 | room temperature |
| 16 | Atotech Noviganth Ni | 10 | 55 |
| | PA | | |
| 17 | Rinse | 1 | room temperature |
| 18 | Copper electroplating | 40 | 35 |
| 19 | Rinse | 1 | room temperature |

TABLE 1
Peel Data

| | Resin | Activation | | |
|---|---|---|---|---|
| | Composition | Process | Rinse | Peel (N/cm) |
| C1 | 1 | 1 | H2O | 2.8 |
| C2 | 2 | 1 | H2O | 5.3 |
| E1 | 1 | 2 | NH4OH | 4.3 |
| E2 | 2 | 2 | NaOH | 10.7 |

What is claimed is:

1. A process for preparing a polyamide article comprising an acid-etchable component for applying a metal coating to saide article, the process comprising the steps of:
(i) treating the polyamide article with an acidic etching treatment to obtain an acid treated polyamide article;
(ii) treating the acid treated polyamide article with a fluoride etching solution to obtain a fluoride treated polyamide article
(iii) treating the fluoride treated polyamide article with a base wash having a pH of between 9-12 to obtain a base washed polyamide article; and
(iv) optionally, applying a metal coating to the base washed polyamide article to obtain a metal-coated polyamide article.

2. The process of claim 1 wherein said polyamide article further comprises reinforcing fibers.

3. The process of claim 2, wherein said polyamide article comprises:
a) from 20 weight % to 79 weight % of aliphatic polyamide,
b) from 10 weight % to 69 weight % semiaromatic polyamide,
c) from 10 weight % to 69 weight % chopped glass fibers, and
d) from 1 weight % to 60 weight % calcium carbonate wherein the weight percentage of each component is based on a 100 weight % total composition.

4. The process of claim 1 wherein said acid etching treatment comprises aqueous hydrochloric acid and ethylene glycol and said acidic etching is carried out at a temperature from about 35° C. to about 55° C. for a period of from about 10 minutes to about 15 minutes.

5. The process of claim 2 wherein said aliphatic polyamide comprises at least 50 weight % hexamethylene adipamide monomer based on 100 weight % of the aliphatic polyamide and said semiaromatic polyamide comprises at least 30 weight % hexamethylene terephthalamide monomer and at least 30 weight % hexamethylene isophthalamide monomer based on 100 weight % of the semiaromatic polyamide.

6. The process of claim 1 wherein said acid etchable component is mineral filler.

7. The process of claim 6, wherein said acid etchable component is calcium carbonate.

8. A process for applying a metal-coating to a polyamide article comprising an acid-etchable component, said process comprising the steps of:
performing the steps of claim 1;
subsequently,
(a) activating the base washed polyamide article with a solution of metal ions to obtain an activated polyamide article;
(b) treating the activated polyamide article with an aqueous reducer solution to obtain a catalytically active polyamide article;
(c) electroless metal plating the catalytically active polyamide article to obtain a metal plated polyamide article;
(d) galvanic metal plating the metal plated polyamide article to a thickness of about 0.1 to 200 microns to obtain a metal coated polyamide article; and
(e) optionally applying a second different metal by galvanic metal plating to obtain a layered metal coated polyamide article.

9. The process of claim 1 wherein the fluoride etching step is performed before the acidic etching step.

10. A metal coated polyamide article obtained by the process of claim 8.

11. The article claim 10 wherein the metal coated polyamide article comprises one or more metal coatings of copper, nickel, iron, cobalt, tin, zinc, aluminum, silver, platinum, titanium, palladium, phosphorus, or metal alloys of them.

12. The metal coated polyamide article of claim 10 in the form of an electrical or electronic component, PDA or component thereof, cell phone component, computer notebook component, portable music player or component thereof, or an electronic book reading device.
